(19) United States
(12) Patent Application Publication
(10) Pub. No.: US 2005/0190836 A1
(43) Pub. Date: Sep. 1, 2005

(54) Process for maximizing the effectiveness of quantization matrices in video codec systems

(76) Inventors: Jiuhuai Lu, Palos Verdes Peninsula, CA (US); Chen Tao, Piscataway, NJ (US); Yoshiichiro Kashiwagi, Arcadia, CA (US); Shinya Kadono, Hyogo (JP)

Correspondence Address: SNELL & WILMER LLP, 1920 MAIN STREET, SUITE 1200, IRVINE, CA, 92614-7230, US

(21) Appl. No.: 11/047,423

(22) Filed: Jan. 31, 2005

Related U.S. Application Data
(60) Provisional application No. 60/540,437, filed on Jan. 30, 2004.

(51) Int. Cl. H04N 7/12

(52) U.S. Cl. 375/240.03; 375/240.18; 375/240.24

(57) ABSTRACT

A method and apparatus evaluates quantization matrices used in video codec systems. Two primary factors are considered in making these estimates. The first is the human visual system contrast sensitivity function. This function measures how well a quantization matrix fits human visual characteristics. The second factor is a typical viewing setting, such as a range of typical viewing distances. For consumer use, the viewing range is one to four times picture height. For professional use, it is assumed the viewing range is one-half to three times picture height. The quantization matrix used in a video codec system defines the quantization step for different frequency bands. This quantization step is essentially equivalent to the allowable error in a frequency band. The present invention evaluates the quantization matrix for its effectiveness in hiding distortion errors. By using this evaluation scheme, the quantization matrix can be modified as needed, and the overall performance of the quantization matrix in a video codec system is improved substantially.

### CROSS-REFERENCE TO RELATED APPLICATIONS

This application claims the benefit of provisional Patent Application No. 60/540,437 filed Jan. 30, 2004, for A Method For Maximizing The Effectiveness Of Quantization Matrices In Video Codec Systems, and hereby incorporates by reference all the contents thereof.

### BACKGROUND OF THE INVENTION

1. Field of the Invention

The present invention relates generally to improvements in video codec systems, and more particularly pertains to new and improved quantization procedures in video codec systems.

2. Description of Related Art

The quantization process is one of the most important processes in video coding systems. Traditionally, quantization involves two major schemes, uniform quantization and use of a quantization matrix. The quantization matrix scheme has been implemented to provide a picture coding system that exploits non-linear human visual perception characteristics. The popularity of quantization matrices has caused them to be utilized in several international video coding standards such as MPEG-2 and MPEG-4. There are still coding standards that use uniform quantization schemes such as H.263 and MPEG-4AVC.

When utilizing the quantization matrix in video codec systems, it is desirable to utilize a system which has the flexibility of using the most appropriate quantization matrix, containing different quantization values or different dimensions, such as 4×4 and 8×8, or different quantization schemes for encoded luminance (luma) and color (chroma) information. To provide this kind of flexibility, the system must be able to evaluate and make decisions as to what matrix to use. The evaluation, for example, would be for the purpose of achieving the same subjective picture quality when both an 8×8 and 4×4 quantization matrix is used within the same picture. Such evaluation could also determine whether different quantization matrices could be used for the luma and chroma in the same transform block.

Prior to the present invention, there has been no process available for determining which quantization matrix would be most effective in a codec system to provide the best subjective picture quality. The present invention provides a technique for evaluating a quantization matrix, for measuring its overall performance in the codec system, for the purpose of obtaining the best subjective picture quality.

### SUMMARY OF THE INVENTION

A method and apparatus for an effective control of quantization process in a lossy moving picture compression that converts received pictures array matrix data structures into bit stream data blocks. In the quantization process, Picture Quality Level is calculated for each pair of a quantization matrix and a quantization step size. A desired Picture Quality Level is compared to a currently calculated Picture Quality Level to determine if the quantization matrix should be adjusted. The quantization matrix may be adjusted, by multiplying each element of the quantization matrix by the ratio of a desired Picture Quality Level with a currently calculated Picture Quality Level.

### BRIEF DESCRIPTION OF THE DRAWINGS

The exact nature of this invention, as well as its objects and advantages, will become readily appreciated upon consideration of the following detailed specification when considered in conjunction with the accompanying drawings, in which like reference numerals designate like parts throughout the figures thereof, and wherein:

FIG. 1 is a block diagram of a video encoder that may utilize the present invention to its advantage.

FIG. 2 is a block diagram of a video decoder that may be utilized with the video encoder of FIG. 1.

FIG. 3 is a diagrammatic illustration of the relationship between frequency of the picture and transform coefficients in a quantization matrix.

FIG. 4 is a diagrammatic illustration of a weighted quantization matrix.

FIG. 5 is a diagrammatic illustration of quantization blocks of different sizes next to each other.

FIG. 6 is a process flow diagram that illustrates quantization matrix evaluation and adjustment, according to the present invention.

FIG. 7 is a block diagram illustrating data flow for determining quantization amounts.

FIG. 8 is a wave diagram illustrating the relationship between human contrast sensitivity function (CSF) to angular frequency, which is representative of the allowable error in a quantization step.

### DETAILED DESCRIPTION OF THE PREFERRED EMBODIMENTS

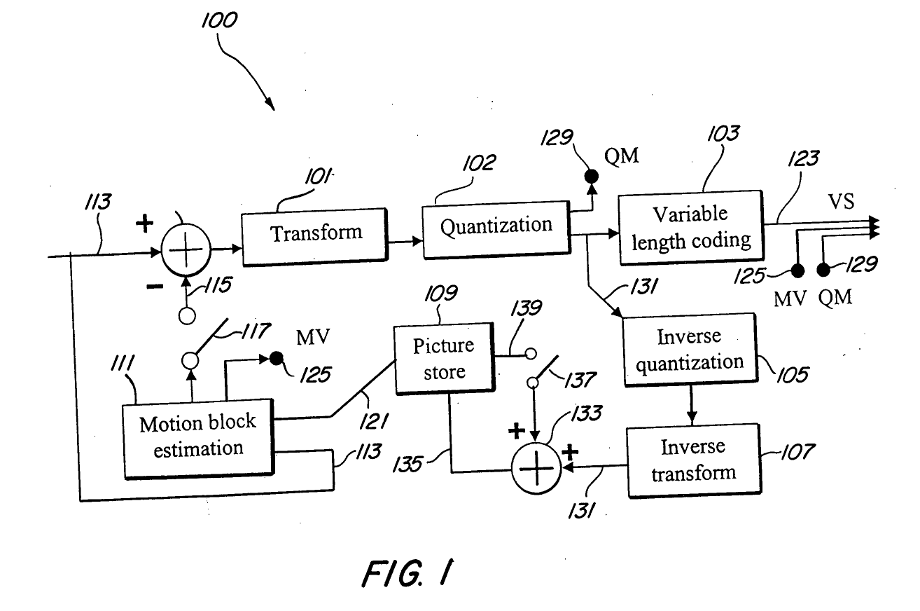

FIG. 1 illustrates a video encoder 100 that utilizes the present application. The picture sequence input 113 is a series of pictures comprised of data structures that describe the pixel values at each pixel of the picture. As is well known, there can be several numbers associated with each pixel. These numbers are, in turn, associated with the intensity of brightness of a certain colored component at the location of that pixel. Typically, a color display combines the brightness of all the colored components to produce the actual color at the location of the pixel.

The output of the video encoder 100 is a plurality of bit streams such as video stream (VS) 123, motion vectors (MV) 125, and quantization matrices QM (129). These data streams are combined together to produce an output that is a series of bits, a bit stream.

The pixel values received by the encoder 100 at its input 113 are supplied to transform circuitry 101 which executes a well understood mathematical conversion that transforms the input picture array into a transform coefficient array. This transform coefficient array is supplied to a quantization circuit 102, which executes a scaling operation performed by multiplying each coefficient of the transform coefficient array by a small number and dividing by a larger number. The output 129 of the quantization circuit 102 is provided as an input to the decoder 140, as an input 131 to variable length coding circuit 103 and as an input to inverse quantization circuit 105. The variable length coding circuit generates the video stream (VS) 123. The inverse operation of the quantization function of quantization circuitry 102. The inverse quantization circuit 105 generates an output of inverse quantization circuit 105 is supplied to an inverse transform circuit 107 which performs a mathematical conversion, converting the transform coefficient array back to a picture array, called the decoded picture. The decoded picture is supplied to a picture store 109. The picture store 109 supplies picture arrays by way of connection 121 to motion block estimation circuit 111, which detects blocks of picture areas with closest fit to the block of pictures being encoded. An output 125 of motion block estimation circuit 111 is motion vector (MV) 125 which becomes part of the bit stream.

Switch 117 selectively supplies information from motion block estimation circuitry 111 to be combined with the data structure representing the series of pictures received at the input 113 to a summing circuit 99. Selector switch 137 selectively supplies a decoded picture stored in picture store 109 to be combined with a decoded picture from the inverse transform circuit 107 by summing circuit 133.

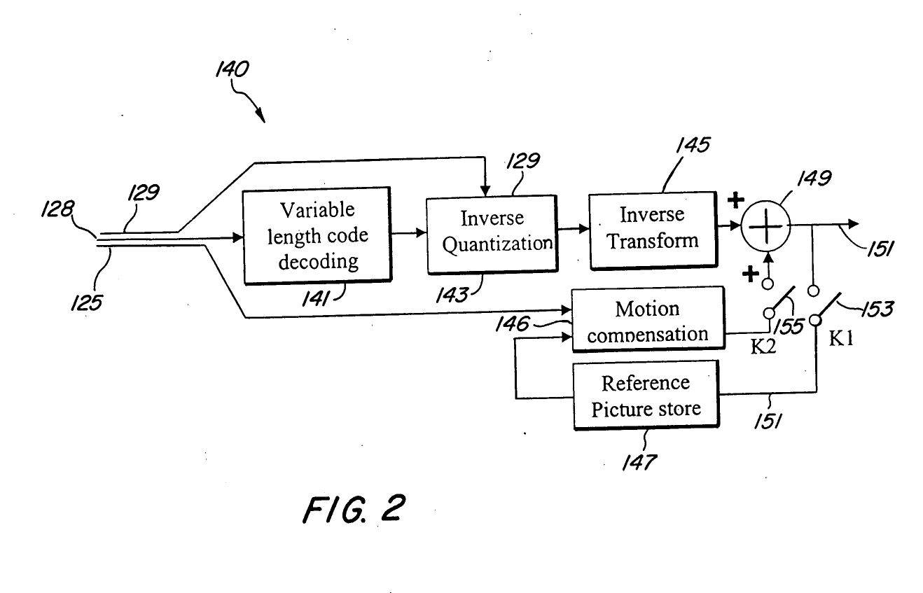

The bit stream output of the encoder 100 of FIG. 1 comprising a video stream (VS) 123, motion vectors (MV) 125 and quantization matrices (QM) 129 are supplied to a video decoder 140 of FIG. 2. The video decoder 140 produces a decoded picture, an output 151, which is a series of pictures, each comprised of a data structure that describes the color intensity values at each pixel in the picture array. These data structures typically include the values of the color component intensities.

A variable length decoding circuit 141 in the video decoder 140 receives video stream data (VS) 123 and converts the variable length code to the actual values represented by the variable length encoded data.

An inverse quantization circuit 143 receives the quantization matrices (QM) 129 from the encoder 100. The quantization matrix is essentially an array of weighting values. A quantization matrix may be assigned to a subarea of a picture or an entire picture, for example. Both the quantization matrix and the overall quantization step size determine the quantity of quantization. The inverse quantization circuit 143 performs an inverse quantization operation which uses the quantization matrix and the overall quantization step size to determine the value of the scaling factor which is multiplied with the quantized coefficients of the transform.

A motion compensation circuit 146 receives the motion vectors (MV) on line 125 from the bit stream and utilizes that information to find a block of pixel values from one of the previous reference pictures stored in the referenced picture store 147. For each picture block outputted from inverse transform circuit 145, a corresponding motion block is determined by the motion vectors associated with that picture block. The pixel values for that motion block obtained from a reference picture are added to the outputted block which is then supplied to a display.

Reference picture store 147 is essentially a memory that stores all the decoded pictures so that they can be used as reference pictures for decoding subsequently received pictures. These reference pictures are referenced by the received motion vectors to obtain the corresponding motion blocks. The K1 switch 153 is open if a picture will not be used as a reference, and will not be supplied to reference picture store 147 over line 51. The K2 switch 155 will be open when the decoding process does not use any reference pictures.

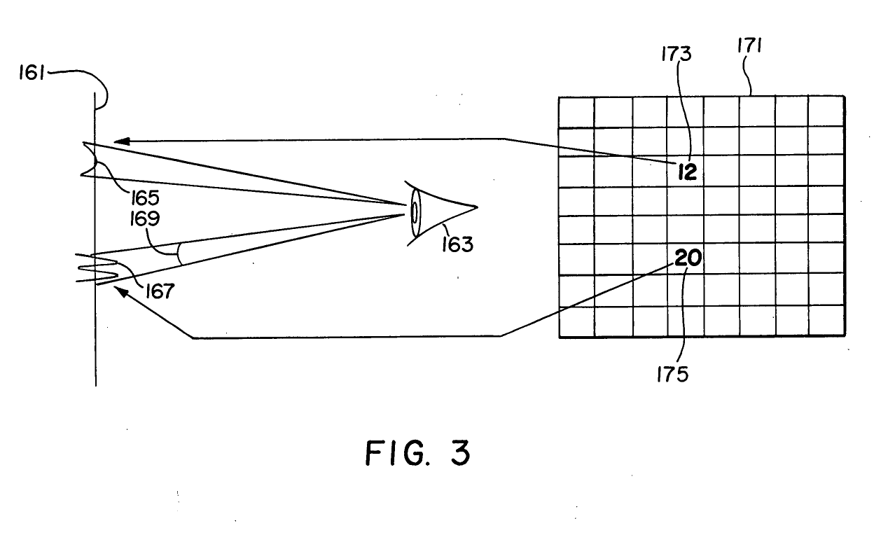

In order to measure the overall performance of the quantization matrices being utilized, two factors must be considered. The first is the human visual system contrast sensitivity function (CSF). This function describes how much contrast sensitivity the human vision system has at different frequency bands. The CSF measures whether a quantization matrix fits human visual characteristics. The second factor is the typical viewing setting for the target picture content. This factor must be considered because the spatial frequency of the CSF is measured in units of viewing degree as shown by viewing angle 169 in FIG. 3. FIG. 3 illustrates a human eye 163 viewing a picture screen which contains picture content at different locations 165 and 167 and different frequencies.

Typically consumer picture content is to be in the range of one to four times picture height. Professional picture content is assumed to be viewed in the range of one-half to three times picture height. The closer the viewing distance, the more visible distortions appear to the viewer 163.

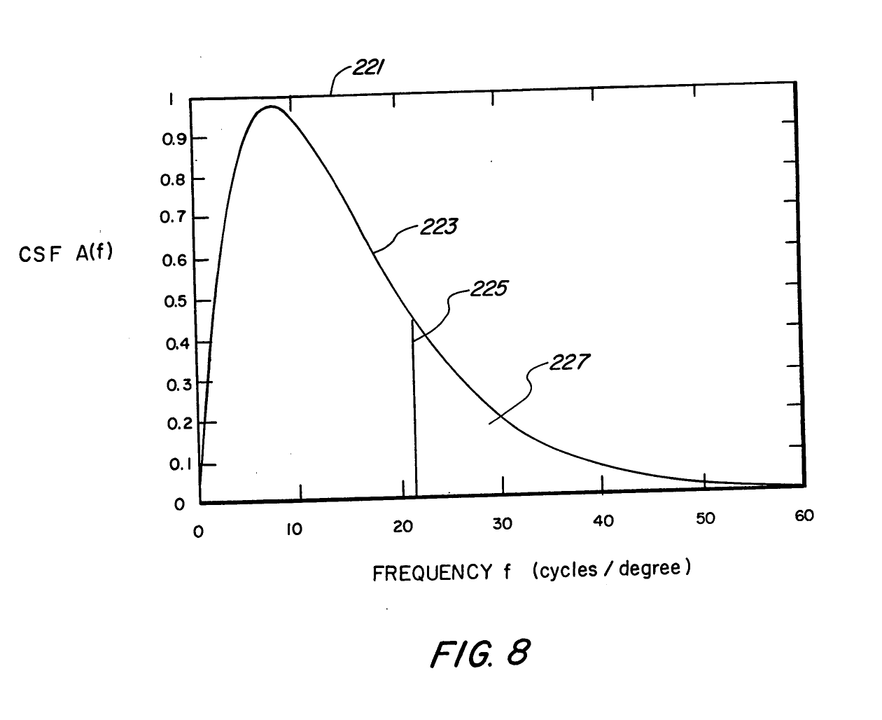

A quantization matrix defines the quantization weights for different frequency bands (approximately). The quantization weights can be essentially determined in proportion to to the allowable error in the angular frequency band. The human vision sensitivity function CSF can be plotted against the angular frequency, producing a relationship, as shown in FIG. 8. The maximum frequency 225 is illustrated by a vertical line on the frequency axis. All higher frequencies are in the sub-pixel range 227.

If a quantization step is small and the visual sensitivity is low, it is likely that any distortion will be less visible. FIG. 3 illustrates transform coefficients C(i,j) 173 and 175 in a transform block 171. Transform coefficient 173 corresponds to a lower frequency sample. Transform coefficient 175 corresponds to a higher frequency sample 167. As illustrated in FIG. 3, transform coefficient 173 C(4,3)=12, and transform coefficient 175 C(4,6)=20.

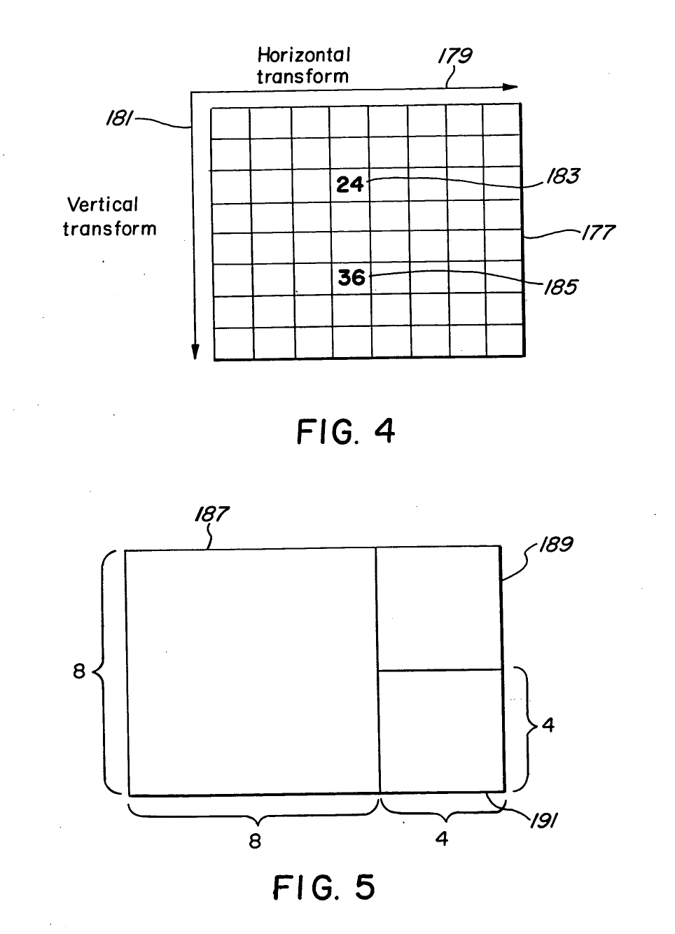

FIG. 4 illustrates a quantization matrix W(i,j) which illustrates how the quantization matrix defines the quantization weighting value, whereby each weighting value is provided to adjust or refine the overall quantization step size already defined directly by the quantization step or by an index to the value of the quantization step. The quantization weighting is illustrated by the following equation:
Quantized (C(i,j))=C(i,j)×K/(Q_step*W(i,j)) 1.

In this equation, where K is a constant, C(i,j) is a coefficient as the result of the transform (transform coefficient) at horizontal location i and vertical location j; Q_step is a quantization step value; and W(i,j) is a weighting at horizontal location i and vertical location j.

The weighted transform coefficients 183 and 185 illustrated in FIG. 3 result from the weighting of transform coefficients C(i,j).

FIG. 5 illustrates transforms of different sizes, 187, 189 and 191 next to each other. The quantization of an 8×8 block 187 uses an 8×8 quantization matrix. Quantization of 4×4 blocks 189 and 191 is accomplished by use of a 4×4 quantization matrix. The present invention contemplates controlling the amount of quantization in an 8×8 block so that when so needed, the amount of quantization applied to the 8×8 block is the same as the amount of quantization in a 4×4 block.

In order to establish a relation between different quantization matrices, for example, a relationship between the quantized luminance information (luma) with a weighting matrix, and color information (chroma) that does not use a quantization matrix, we can define a Picture Quality Index, which is essentially a weighted sum of the quantization coefficients. This value is then used to represent the suitableness of a quantization matrix for maintaining a certain subjective picture quality.

This quantization matrix Picture Quality Index (QI) is computed on the basis of the human vision contrast sensitivity function (CSF) and the purpose of the picture content, such as consumer use or professional use. If we define a quantization matrix (QM) as follows,
QM={{q₁₁, q₁₂, . . . q₁₈}, {q₂₁, q₂₂, . . . q₂₈}, . . . , {q₈₁, q₈₂, . . . q₈₈}} 2.
the Picture Quality Index can be derived from a general formula of summing subjective quality distortion from different sources as follows:
QI=((a₁₁q₁₁)^{p}+(a₁₂q₁₂)^{p}+ . . . +(a₁₈q₁₈)^{p}+(a₂₁q₂₁)^{p}+ . . . +(a₈₈q₈₈)^{p})^{1/p}/matrix size 3.

The value of p in the above equation is usually between 2 or 3. For simplicity, however, we can choose to use p=1, which simplifies the equation as follows:
QI=(a₁₁q₁₁+a₁₂q₁₂)+ . . . +a₁₈q₁₈+a₂₁q₂₁+ . . . +a₈₈q₈₈)/matrix size 4.
Matrix size in Equations 3 and 4 equals the total elements in a matrix.

The weighting values aᵢⱼ in Equations 3 and 4 suggest different degrees of error sensitivity in visual perception. They have different values at each location of the quantization matrix. The weighting value aᵢⱼ is determined by mainly two factors. The first is the spatial frequencies corresponding to the locations of the coefficients. The second is the representative viewing conditions associated with the intended coding content.

Entries of the quantization matrix corresponding to different spatial frequency components may have different values reflecting different error sensitivity and visual perception at different frequency components. In addition, each component in a quantization matrix may have different visual sensitivity when viewing is at a different distance. As stated earlier, for consumer quality video, we shall assume the distance is in a range of one to four times the picture height. For professional quality video, we shall assume the distance in the range of one-half to three times the picture height. Assuming a viewing range of one to four times picture height and an 8×8 quantization matrix, we can obtain the derived error sensitivity weighting as follows:
aᵢⱼ=KΣ_{n=1 . . . 3}CSF(tan⁻¹(1/((min(i,j)−1)*pict₋height_{—in}_mb_unit*n))), i,j>1 5.
a₁₁=KΣ_{n=1 . . . 3}CSF(tan⁻¹(1/(pict_height_in_mb_unit*n) 6.

Assuming a 4×4 quantization matrix, the error sensitivity weighting is:
aᵢⱼ=KΣ_{n=1 . . . 3}CSF(tan⁻¹(1/(2*(min(i,j)−1)*pict_height_in_mb_unit*n))), i,j>1 7.
a₁₁=KΣ_{n=1 . . . 3}CSF(tan⁻¹(1/(2*pict_height_in_mb_unit*n))) 8.

Because tan⁻¹ ( ) in the above equations is typically very small, they can be simplified as the follows:

For 8×8 block,
aᵢⱼ=KΣ_{n=1 . . . 3}CSF(1/((min(i,j)−1)*pict_height_in_mb_unit*n)), for i,j>1 9.
a₁₁=KΣ_{n=1 . . . 3}CSF(1/(pict_height_in_mb_unit*n)) 10.

For 4×4 block,
aᵢⱼ=KΣ_{n=1 . . . 3}CSF(1/(2*(min(i,j)−1)*pict_height_in_mb_unit*n)), i,j>1 11.
a₁₁=KΣ_{n=1 . . . 3}CSF(1/(2*pict_height_in_mb_unit*n)) 12.
These weighting coefficients can be computed beforehand and specified once the quantization matrix is specified.

The overall quantization step size can be represented by a quantization parameter (QP), essentially an index to a quantization-step table. A QP is mapped to a quantization step size value by look-up in a quantization step table. QP and the quantization step size are related monotonically, i.e., QP goes up, the quantization step size goes up. The quantization matrix must be used together with QP. For each quantization matrix, we can compute the equivalent quantization scaler of an 8×8 quantization matrix by the following general formula:
Q_{mOpeq}=((a₁₁q₁₁)^{p}+(a₁₂q₁₂)^{p}+ . . . +(a₁₈q₁₈)^{p}+(a₂₁q₂₁)^{p}+ . . . +a₈₈q₈₈)^{p})^{1/p}/(a₁₁^{p}+a₁₂^{p}+ . . . +a₁₈^{p}+a₂₁^{p}+ . . . +a₈₈^{p})^{1/p} 13.

The equivalent quantization scaler of a quantization matrix is further used to derive the Picture Quality Level or the Equivalent Quantization Parameter for each pair of quantization matrices and a Quantization Parameter (QP).
Q=QuantizationStepSize(QP)*Q_{mOpeq} 14.
Where the mapping function QuantizationStepSize(QP) is the quantization step size associated with QP.

By setting p equal to 1, Equation 13 can be simplified to:
Q_{mOpeq}=(a₁₁q₁₁+a₁₂q₁₂+ . . . +a₁₈q₁₈+a₂₁q₂₁+ . . . +a₈₈q₈₈)/(a₁₁+a₁₂+ . . . +a₁₈+a₂₁+ . . . +a₈₈) 15.

Equation 13 can also be simplified so that aᵢⱼ are either 1 or 0. The assignment of 1 and 0 to aᵢⱼ can follow the following relationship:

aᵢⱼ=1, for i, j satisfying i+j<M. For example, M=4 for 4×4 matrix and M=7 for 8×8 matrix.

In a similar manner, the equivalent quantization scaler for a 4×4 quantization matrix can be obtained. The quantization scaler can be used to look up quantization parameter equivalent value in an MPEG-4AVC specification, for example.

In implementation, these values are either computed off-line and kept in tables or are computed by encoders. However, to make a customized quantization matrix and video codec default matrix work together, a customized quantization matrix transmitted to the decoder must use the same scaler as the video codec default matrix.

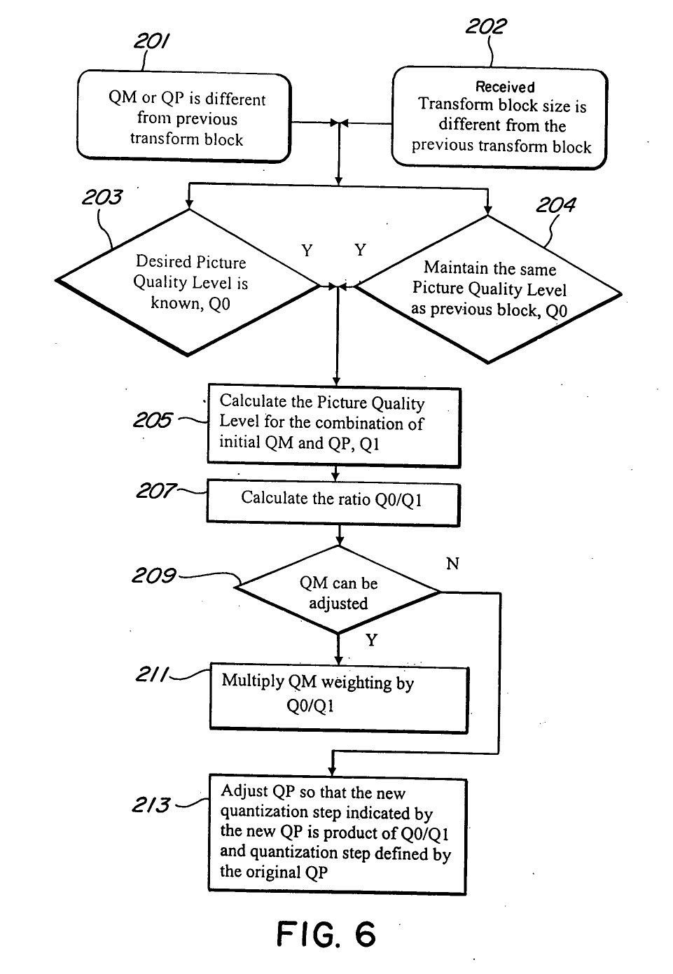

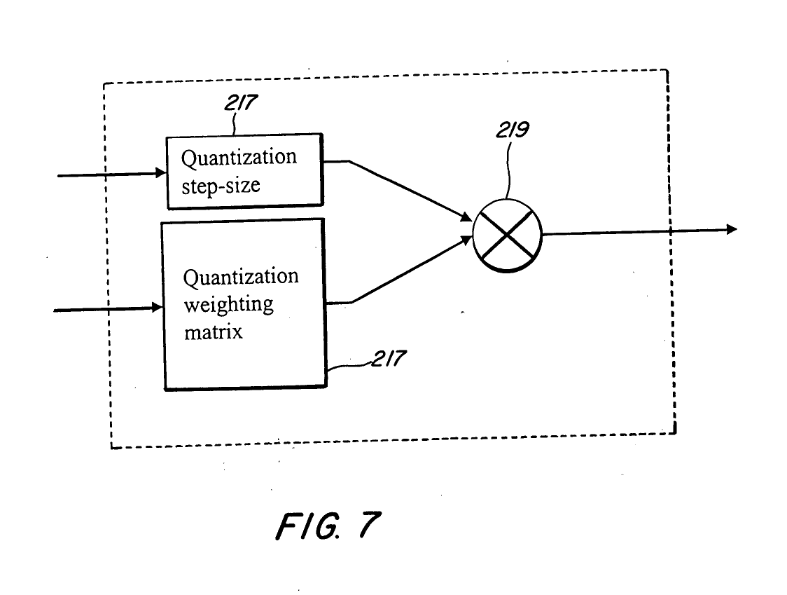

FIG. 6 illustrates the implementation of the present invention as a picture quantization subsystem within a video codes system. Referring to the coding system of FIG. 1, the subsystem would operate as a subsystem within quantization circuit 102.

The picture quantization subsystem illustrated in FIG. 6 is activated by a quantization weighting matrix (QM), or quantization parameter index (QP) 201, or a quantization step size 202. Thus, if QM or QP, as currently received, is different from the QM or QP of a previous transform block, or the currently received transform block size is different from a previous transform block, the quantization subsystem of FIG. 6 is activated. If QM or QP of a chrominance block as currently received is different from QM and QP of the luminance block and different from QM and QP of the other chrominance blocks, the quantization subsystem of FIG. 3 is also activated. The transform block size may be any one of a variety of different coding sizes. For example, 2×2, 4×4, 8×8, 8×4, 4×8, 16×16, n×m, where n and m are integers.

Upon the picture quantization subsystem being activated, it is first determined whether the desired picture quality level (Q₀) is known (203), whether the same picture quality (Q₀) as the previous block should be maintained 204, or whether the same picture quality (Q₀) as other chrominance of the current block should be maintained. A positive response to either one of these questions will cause the subsystem to calculate the Picture Quality Level (Q₁) for the combination of the quantization weighting matrix and quantization parameter to obtain the calculated Picture Quality Level (Q₁) for the currently received transform block 205. The picture quality level calculation is performed according to the Equation 3 or, in simplified form, Equation 4 set forth above.

Once Picture Quality Level (Q₁) has been determined, the ratio of the Picture Quality Level of the previous block to the calculated Picture Quality Level

$$\frac{{Q}_{0}}{{Q}_{1}}$$

is calculated. This ratio will determine (209) whether the quantization matrix QM can be adjusted. If it can be adjusted, the quantization weighting matrix QM is multiplied (211) by the ratio of

$$\frac{{Q}_{0}}{{Q}_{1}}$$

at each quantization point.

If the quantization matrix QM cannot be adjusted, then the quantization parameter is adjusted (213) so that the new quantization step indicated by the newly adjusted quantization parameter is a product of

$$\frac{{Q}_{0}}{{Q}_{1}} .$$

1. A method of processing an image, comprising the steps of:
receiving picture array data structures;
converting the data structures into bit stream data by applying a mathematical transform to each block of pictures;
applying a quantization parameter and a quantization matrix to the transform of each block; and
calculating a Picture Quality Level for each combination of quantization parameter and quantization matrix.

2. The method of claim 1 wherein the quantization matrix is expressed by the equation:
Q={{q₁₁, q₁₂, . . . q₁₈}, {q₂₁, q₂₂, . . . q₂₈}, . . . , {q₈₁, q₈₂, . . . q₈₈}}

3. The method of claim 2 wherein the Picture Quality Level is calculated according to the equation:
Q=((a₁₁q₁₁)^{p}+(a₁₂q₁₂)^{p}+ . . . +(a₁₈q₁₈)^{p}+(a₂₁q₂₁)^{p}+ . . . +a₈₈q₈₈)^{p})^{1/p}/(a₁₁^{p}+a₁₂^{p}+ . . . +a₁₈^{p}+a₂₁^{p}+ . . . +a₈₈^{p})^{1/p}
where a represents a weighting coefficient.

4. The method of claim 1 further comprising the steps of:
obtaining the ratio of a previously obtained Picture Quality Level with a currently calculated Picture Quality Level.

5. In the method of claim 4, if the current block is a chrominance block, computing the previously obtained Picture Quality Level on a luminance block of the picture or another chrominance block of the picture being coded.

6. In the method of claim 3, simplifying the equation by setting the coefficients a to either 1 or 0, wherein a is 0 if the sum of the two indexes is less than a certain value.

7. The method of claim 4 wherein the quantization matrix is expressed by the equation:
QM={{q₁₁, q₁₂, . . . q₁₈}, {q₂₁, q₂₂, . . . q₂₈}, . . . , {q₈₁, q₈₂, . . . q₈₈}}

8. The method of claim 7 wherein the Picture Quality Level is calculated according to the equation:
Q=((a₁₁q₁₁)^{p}+(a₁₂q₁₂)^{p}+ . . . +(a₁₈q₁₈)^{p}+(a₂₁q₂₁)^{p}+ . . . +a₈₈q₈₈)^{p})^{1/p}/(a₁₁^{p}+a₁₂^{p}+ . . . +a₁₈^{p}+a₂₁^{p}+ . . . +a₈₈^{p})^{1/p}
where a represents a weighting coefficient.

9. The method of claim 4 further comprising the steps of:
determining if the quantization matrix used in the converting step should be adjusted; and
adjusting the quantization matrix by multiplying each element of the quantization matrix by a ratio of a previously obtained Picture Quality Level with a currently calculated Picture Quality Level.

10. The method of claim 9 wherein the determining step comprises calculating the ratio
$$\frac{{Q}_{0}}{{Q}_{1}} ;$$
where Q₀ is a previously calculated Picture Quality Level and Q₁ is a currently calculated Picture Quality Level.

11. The method of claim 9 wherein the adjusting step comprises using the ratio
$$\frac{{Q}_{0}}{{Q}_{1}} ;$$
where Q₀ is a previously calculated Picture Quality Level and Q₁ is a currently calculated picture quality index.

12. The method of claim 7 wherein a Picture Quality Index (QI) is calculated according to the equation:
QI=((a₁₁q₁₁)^{p}+(a₁₂q₁₂)^{p}+ . . . +(a₁₈q₁₈)^{p}+(a₂₁q₂₁)^{p}+ . . . +(a₈₈q₈₈)^{p})^{1/p}/matrix size
where matrix size equals the total elements in the matrix and a represents weighting coefficients.

13. An apparatus for processing an image, comprising:
means for receiving picture array data structures;
means for converting the received data structures into bit stream data by applying a mathematical transform to each block of pictures;
means for applying a quantization parameter and a quantization matrix to the transformer of each block; and
means for calculating a Picture Quality Level for each combination of quantization parameter and quantization matrix.

14. The apparatus of claim 13 wherein the quantization matrix used by the converting means is expressed by the equation:
QM={{q₁₁, q₁₂, . . . q₁₈}, {q₂₁, q₂₂, . . . q₂₈}, . . . , {q₈₁, q₈₂, . . . q₈₈}}

15. The apparatus of claim 14 wherein the Picture Quality Level is calculated according to the equation:
Q=((a₁₁q₁₁)^{p}+(a₁₂q₁₂)^{p}+ . . . +(a₁₈q₁₈)^{p}+(a₂₁q₂₁)^{p}+ . . . +(a₈₈q₈₈)^{p})^{1/p}/(a₁₁^{p}+a₁₂^{p}+ . . . +a₁₈^{p}+a₂₁^{p}+ . . . +a₈₈^{p})^{1/p}
wherein a represents weighting coefficients.

16. The apparatus of claim 13 further comprising:
means for calculating the ratio of a previously calculated Picture Quality Level with a currently calculated Picture Quality Level.

17. The apparatus of claim 16 wherein if the current block is a chromium block, the previously obtained Picture Quality Level is computed on a luminance block of the picture or another chromium block of the picture being coded.

18. The apparatus of claim 15 wherein the equation can be simplified by setting the coefficient a to either 1 or 0, wherein a is 0 if the sum of the two indexes is less than a certain value.

19. The apparatus of claim 16 wherein the quantization matrix used by the converting means is expressed by the equation:
QM={{q₁₁, q₁₂, . . . q₁₈}, {q₂₁, q₂₂, . . . q₂₈}, . . . , {q₈₁, q₈₂, . . . q₈₈}}

20. The apparatus of claim 19 wherein the picture quality index is calculated according to the equation:
Q=((a₁₁q₁₁)^{p}+(a₁₂q₁₂)^{p}+ . . . +(a₁₈q₁₈)^{p}+(a₂₁q₂₁)^{p}+ . . . +(a₈₈q₈₈)^{p})^{1/p}/(a₁₁^{p}+a₁₂^{p}+ . . . +a₁₈^{p}+a₂₁^{p}+ . . . +a₈₈^{p})^{1/p}
wherein a represents weighting coefficients.

21. The apparatus of claim 16 further comprising:
means for determining whether the quantization matrix used in the converting means should be adjusted; and
means for adjusting the quantization matrix by multiplying each element of the quantization matrix by a ratio of a previously obtained Picture Quality Level with a currently calculated Picture Quality Level.

22. The apparatus of claim 21 wherein the determining means comprises calculating the ratio
$$\frac{{Q}_{0}}{{Q}_{1}}$$
where Q₀ is a previously calculated Picture Quality Level and Q₁ is a currently calculated Picture Quality Level.

23. The apparatus of claim 21 wherein the adjusting means comprises using the ratio
$$\frac{{Q}_{0}}{{Q}_{1}}$$
where Q₀ is a previously calculated Picture Quality Level and Q₁ is a currently calculated Picture Quality Level.

24. The apparatus of claim 14 wherein a Picture Quality Index (QI) is calculated according to the equation:
QI=((a₁₁q₁₁)^{p}+(a₁₂q₁₂)^{p}+ . . . +(a₁₈q₁₈)^{p}+(a₂₁q₂₁)^{p}+ . . . +(a₈₈q₈₈)^{p})^{1/p}/matrix size
wherein matrix size equals the total elements in the matrix and a represents weighting coefficients.
